(19) United States
(12) Patent Application Publication
(10) Pub. No.: US 2018/0143974 A1
(43) Pub. Date: May 24, 2018

(54) TRANSLATION ON DEMAND WITH GAP FILLING

(71) Applicant: Microsoft Technology Licensing, LLC, Redmond, WA (US)

(72) Inventors: Evgeny Skarbovsky, Sammamish, WA (US); Frank Tompkins Spokane, Washington, DC (US); Gregory Paul Baribault, Sammamish, WA (US)

(73) Assignee: Microsoft Technology Licensing, LLC, Redmond, WA (US)

(21) Appl. No.: 15/382,531

(22) Filed: Dec. 16, 2016

Related U.S. Application Data
(60) Provisional application No. 62/424,221, filed on Nov. 18, 2016.

(51) Int. Cl. G06F 17/28

(52) U.S. Cl. CPC G06F 17/289; G06F 17/2836

(57) ABSTRACT

The functionality of devices used to translate transcribed events is augmented to provide on-demand translations as well as prioritized gap filling in incomplete translations. In various aspects, the transcript is provided as a readout or as captioning that is presented in concert with the event being transcribed. When an initial request for translated captioning is made, the translated captions are generated in near real-time and provided to the requestor for as long as the requestor continues to view the event. In some aspects, generation and provision of translated captions cease once the requestor is no longer consuming captions in the given language. In additional aspects, translation of as-of-yet untranslated portions of the transcript for a given language (i.e., gaps), are filled according to a prioritization scheme, so that translated transcripts may be provided for the entire transcript for users in various languages.

### RELATED APPLICATIONS

This application claims priority from U.S. Provisional Patent Application No. 62/424,221 titled, “TRANSLATION ON DEMAND WITH GAP FILLING” and having a filing date of Nov. 18, 2016, which is incorporated herein by reference.

### BACKGROUND

A meeting, webinar, or other online or broadcast event may be transcribed to text and presented as captions to an audience. The transcription that results may be made available for download following the event. When the text captions are machine generated, as through a speech-to-text engine, mistakes are inevitable. Such mistakes make understanding the text more difficult, and distract from the viewing experience.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

To improve the quality of transcripts produced for an event, and to optimize the expenditure of computing resources used to produce those transcripts in a variety of languages, on demand translation and gap filling are provided. In response to receiving a request to translate an event's transcript into a second language, the transcript will begin being provided to a requestor according to the second language. In various aspects, the translated transcript is provided during the event to be transcribed or after the event to be transcribed has completed. In various aspects, the transcript is provided as a readout or as captioning that is presented in concert with the event being transcribed.

When an initial request for translated captioning is made, the translated captions are generated and provided to the requestor for as long as the requestor continues to view the event. In some aspects, generation and provision of translated captions cease once the requestor is no longer consuming captions in the given language. In additional aspects, translation of as-of-yet untranslated portions of the transcript for a given language (i.e., gaps), are filled according to a prioritization scheme, so that translated transcripts may be provided for the entire transcript for users in various languages.

Requests for translation indicate desired time ranges in a content item from which to provide captioning and desired languages for the captions. In various aspects, a desired language is specified, while in other aspects it is inferred based on information related to a source location or user and a destination location or user profiles available to the transcript database.

Through implementation of this disclosure, the functionalities of the computing devices that are employed in transcription or captioning are improved. For example, the speech-to-text algorithm may be improved and made more efficient through prioritizing various languages in which to transcribe a content item based on the provided contexts. By handling a contextual request for transcription for the speech to text engine, fewer computing resources need to be devoted to constructing the transcript and those computing resource are employed more efficiently.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 illustrates an example operating environment in which the construction and provision of on demand of translated transcripts may be practiced;

FIGS. 2A-E are example graphical user interfaces in which the various aspects of the disclosure are illustrated;

FIGS. 3A and 3B are flow charts showing general stages involved in example methods for providing on-demand transcription and translations thereof;

FIG. 4 is a block diagram illustrating example physical components of a computing device;

FIGS. 5A and 5B are block diagrams of a mobile computing device; and

FIG. 6 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

To improve the quality of transcripts produced for an event, and to optimize the expenditure of computing resources used to produce those transcripts in a variety of languages, on demand translation and gap filling are provided. In response to receiving a request to translate an event's transcript into a second language, the transcript will begin being provided to a requestor according to the second language. In various aspects, the translated transcript is provided during the event to be transcribed or after the event to be transcribed has completed. In various aspects, the transcript is provided as a readout or as captioning that is presented in concert with the event being transcribed.

When an initial request for translated captioning is made, the translated captions are generated and provided to the requestor for as long as the requestor continues to view the event. In some aspects, generation and provision of translated captions cease once the requestor is no longer consuming captions in the given language. In additional aspects, translation of as-of-yet untranslated portions of the transcript for a given language (i.e., gaps), are filled according to a prioritization scheme, so that translated transcripts may be provided for the entire transcript for users in various languages

Requests for translation indicate desired time ranges in a content item from which to provide captioning and desired languages for the captions. In various aspects, a desired language is specified, while in other aspects it is inferred based on information related to a source location or user and a destination location or user profiles available to the transcript database.

Through implementation of this disclosure, the functionalities of the computing devices that are employed in transcription or captioning are improved. For example, the speech-to-text algorithm may be improved and made more efficient through prioritizing various languages in which to transcribe a content item based on the provided contexts. By handling a contextual request for transcription for the speech to text engine, fewer computing resources need to be devoted to constructing the transcript and those computing resource are employed more efficiently.

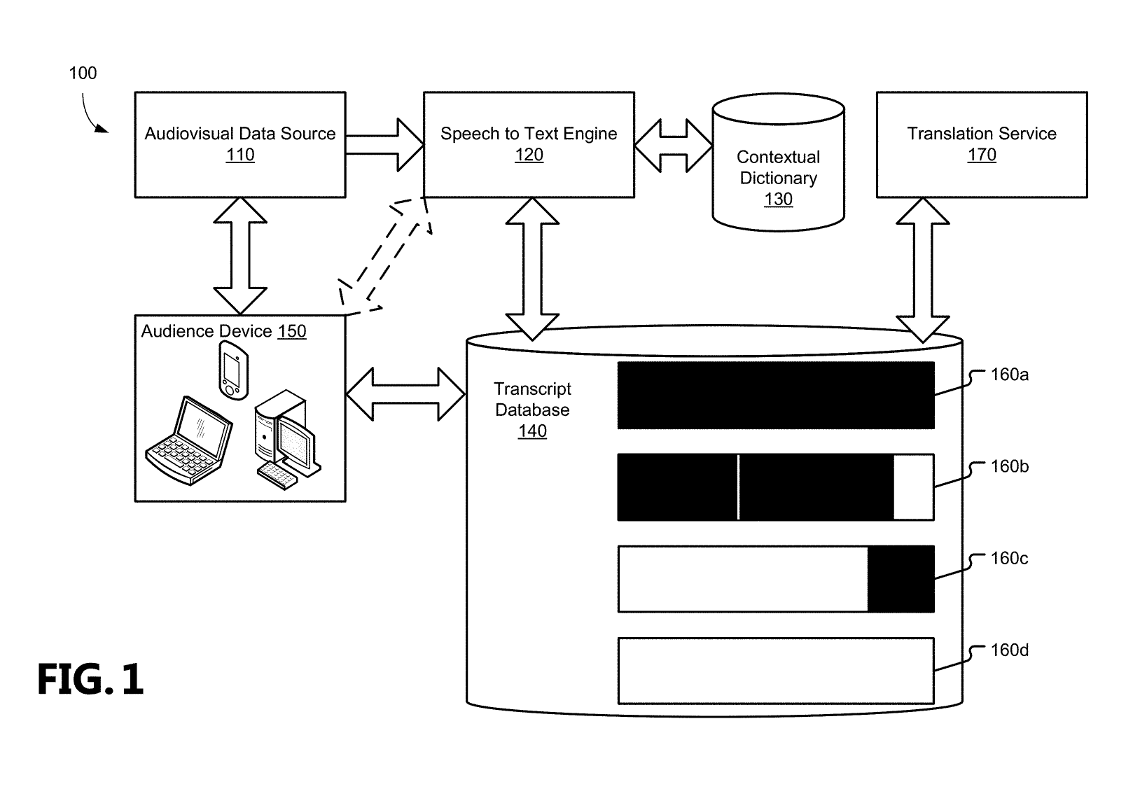

FIG. 1 illustrates an example operating environment 100 in which the construction and provision of on demand translated transcripts may be practiced. As illustrated, an audiovisual data source 110 communicates audiovisual data to a speech to text engine 120 and to audience devices 150. The speech to text engine 120 converts speech data in the audiovisual data into text with the aid of a contextual dictionary 130, defining various words into which phonemes are to be translated, and stores the text of those words in a transcript database 140. The transcript database 140 provides the text as captioning data for consumption by the audience devices 150 (and optionally the audiovisual data source 110) in association with the audiovisual data, and as a document of the transcript. The transcript database 140 is configured to maintain various versions of the transcript according to different languages and conversion schemes. As illustrated, four transcriptions 160 are maintain for a given content item, but as will be appreciated, more or fewer transcriptions 160 may be maintained in other aspects. The transcriptions 160 in various languages are produced by a translation service 170 in communication with the transcript database 140 based on a transcription 160 made in an initial language (or languages) of the event.

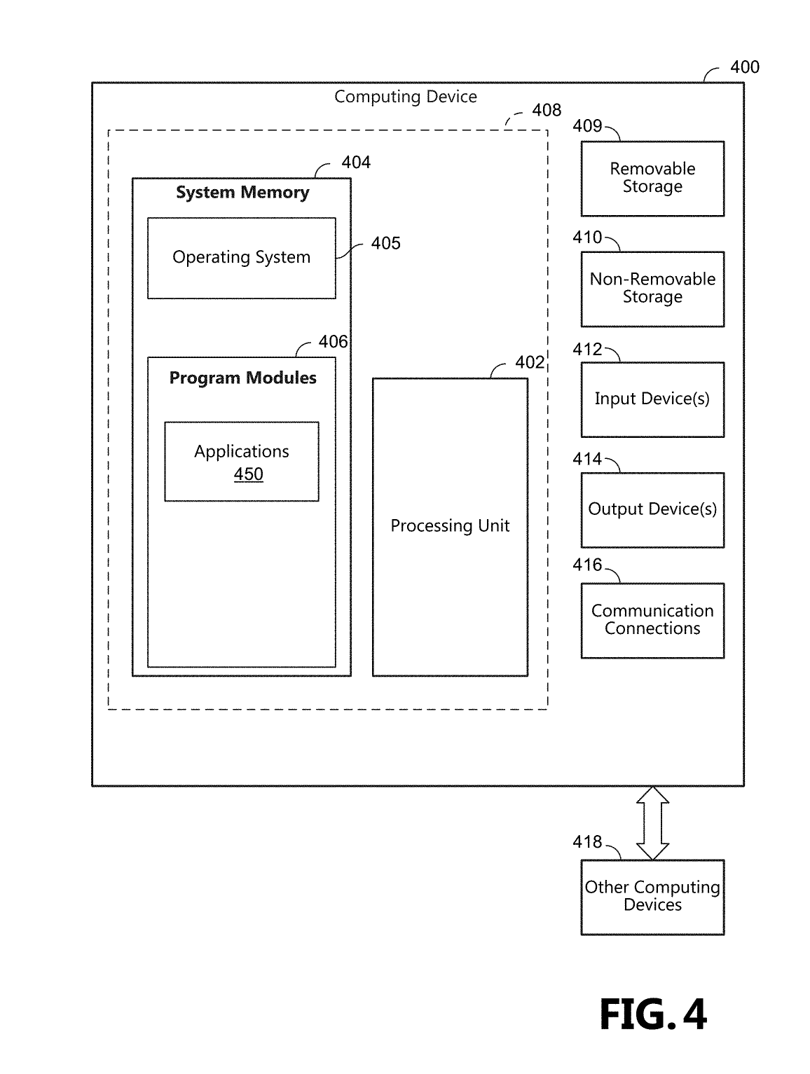

The audiovisual data source 110, speech to text engine 120, contextual dictionary 130, transcript database 140, audience devices 150, and translation services 170 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, printers, and mainframe computers. The hardware of these computing systems is discussed in greater detail in regard to FIGS. 4-6.

While audiovisual data source 110, speech to text engine 120, contextual dictionary 130, transcript database 140, audience devices 150, and translation services 170 are shown remotely from one another for illustrative purposes, it should be noted that several configurations of one or more of these devices hosted locally to another illustrated device are possible, and each illustrated device may represent multiple instances of that device (e.g., the audience device 150 represents all of the devices used by the audience of the audiovisual data). Various servers and intermediaries familiar to those of ordinary skill in the art may lie between the component systems illustrated in FIG. 1 to route the communications between those systems, which are not illustrated so as not to distract from the novel aspects of the present disclosure.

The audiovisual data source 110 is the source for audiovisual data, which includes audiovisual data that is “live” or pre-recorded and broadcast to several audience devices 150 or unicast to a single audience device 150. In several aspects, “live” broadcasts include a transmission delay. For example, a television program that is filmed “live” is accompanied by a delay of n seconds before being transmitted from the audiovisual data source 110 to audience devices 150 to allow for image and sound processing, censorship, the insertion of commercials, etc. The audiovisual data source 110 in various aspects includes content recorders (e.g., cameras, microphones), content formatters, and content transmitters (e.g., antennas, multiplexers). In various aspects, the audiovisual data source 110 is also an audience device 150, such as, for example, when two users are connected on a teleconference by their devices, each device is an audiovisual data source 110 and an audience device 150.

Audiovisual data provided by the audiovisual data source 110 include data formatted as fixed files as well as streaming formats that include one or more sound tracks (e.g., Secondary Audio Programming (SAP)) and optionally include video tracks. The data may be split across several channels (e.g., left audio, right audio, video layers) depending on the format used to transmit the audiovisual data. In various aspects, the audiovisual data source 110 includes, but is not limited to: terrestrial, cable, and satellite television stations and on-demand program providers; terrestrial, satellite, and Internet radio stations; Internet video services, such as, for example, YOUTUBE® or VIMEO® (respectively offered by Alphabet, Inc. of Mountain View, Calif. and InterActiveCorp of New York, N.Y.); Voice Over Internet Protocol (VOIP) and teleconferencing applications, such as, for example, WEBEX® or GOTOMEETING® (respectively offered by Cisco Systems, Inc. of San Jose, Calif. and Citrix Systems, Inc. of Fort Lauderdale, Fla.); and audio/video storage sources networked or stored locally to an audience device 150 (e.g., a “my videos” folder).

The speech to text engine 120 is an automated system that receives audiovisual data and creates text, timed to the audio portion of the audiovisual data to create a transcript that may be played back in association with the audiovisual data as captions. In various aspects, the speech to text engine 120 provides data processing services based on heuristic models and artificial intelligence (e.g., machine or reinforcement learning algorithms) to extract speech from other audio data in the audiovisual data. For example, when two persons are talking over background noise (e.g., traffic, a song playing in the background, ambient noise), the speech to text engine 120 is operable to provide conversion for the speech, but not the background noises, by using various frequency filters, noise level filters, or channel filters on the audio data to isolate the speech data.

The contextual dictionary 130 provides a list of words and the phonemes from which those words are comprised to the speech to text engine 120 to match to the speech data of the audiovisual data. Although examples are given herein primarily in the English language, speech to text engines 120 and contextual dictionaries 130 are provided in various aspects for other languages, and a user may specify one or more languages to use in creating the transcript by specifying an associated speech to text engines 120 and contextual dictionary 130. Non-English language examples given herein will be presented using Latin text and translations (where appropriate) will be identified with guillemets (i.e., the symbols “«” and “»”). Phonemes may also be discussed in symbols associated with the International Phonetic Alphabet (IPA) for English, which will be identified with square brackets (i.e., the symbols “[” and “]”) around the examples in the present disclosure to distinguish IPA examples from standard written English examples.

For words with identical or similar phonemes, such as homophones, the contextual dictionary 130 will provide multiple potential words that the speech to text engine 120 is operable to select from, based on syntax and context of the data it is translating. The speech to text engine 120 will select the entry for which it has the highest confidence in matching the identified phonemes from the contextual dictionary 130 to provide in the transcript. The speech to text engine 120 is further configured in some aspects to provide the next n-best alternatives to the best entry as suggested replacements to users; those entries with the next-most highest confidences as matching the phonemes.

The contextual dictionary 130 is augmented from a base state (e.g., a standard dictionary, a prior-created contextual dictionary 130) to include terminology discovered via context mining from the event to be transcribed. For example, a meeting event may be mined to discover its attendees, a title and description, and documents attached to that meeting event. These data are parsed to derive contextual information about the event, and are used as a starting point to mine for additional data according to a relational graph in communication with one or more databases and file repositories. Continuing the example, the names of the attendees and terms parsed from the title description and attached documents are added to the contextual dictionary 130, and are used to discover additional, supplemental contextual information for inclusion in the contextual dictionary 130. In some aspects, a user interface is provided to alert a user to the terminology affected in the contextual dictionary 130 by the discovered contextual information and supplemental information, as well as to manually personalize terminology in the contextual dictionary 130 by adding terms or influencing weightings of those terms in the contextual dictionary 130.

In various aspects, weightings or personalizations are made to the contextual dictionary 130 as feedback is received on the textual data provided in the transcript so that the choices made by the speech to text engine 120 are influenced by the feedback. For example, if the speakers in the audio data speak with an accent, the speech to text engine 120 may select incorrect words from the contextual dictionary 130 based on the unfamiliar phonemes used to pronounce the accented word. As pronunciation feedback is received to select corrected text, the word associated with the corrected text will have its confidence score in the contextual dictionary 130 increased so that the given word will be provided to the speech to text engine 120 (even if it were not before) when the phonemes are encountered again. In various aspects, pronunciation feedback specifies one of a selection of accents known for a given language or characteristics of an accent (e.g., elongated/shortened vowels, rhotic/non-rhotic, t-glottalization, flapping, consonant switches, vowel switches).

Confidence scores for a word (or words) for a given set of phonemes are influenced by an exactness of the recognized phonemes from the speech data matching stored phonemes associated with the word in the contextual dictionary 130, but also include personalization for pronunciation feedback, corrections to the transcript, and frequency of use for given words in a given language (i.e., how commonly a given word is expected to be used). For example, the words “the” and “thee” share the same phonemes in certain situations (i.e., a person may pronounce the two words identically as Pip, but the contextual dictionary 130 will associate a higher confidence score with “the” as it is used more frequently in modern English speech than “thee”. However, if the speaker is noted in feedback as using archaic English speech (e.g., in a reenactment or a period drama set in a time using archaic speech, quoting from an archaic document) or the word “the” is corrected to “thee”, the contextual dictionary 130 is personalized to the audiovisual content item to provide a greater relative confidence score to the word “thee” compared to “the” when converting the audiovisual content item's speech data into textual data. The contextual dictionary 130 may be applied to a single audiovisual content item or specified to be used for a subsequent audiovisual content item (e.g., the next episode in a series, a subsequent lecture) instead of a non-contextual dictionary. In various aspects, the speech to text engine 120 is configured to use the confidence scores provided by the contextual dictionary 130 along with its own scoring system, which may take into account syntax and grammar, to produce confidence scores for phoneme to word matching that account for other identified words.

In various aspects, the contextual dictionary 130 is provided with contextual information related to the event being transcribed and its participants from various databases. The contextual information provide names and terms to expand the vocabulary available from the contextual dictionary 130, and are used to provide supplemental contextual information, to further augment the contextual dictionary 130, from a graph database that is automatically mined for supplemental contextual information based on the contextual information of the event.

A graph database provides one or more relational graphs with nodes describing entities and a set of accompanying properties of those entities, such as, for example, the names, titles, ages, addresses, etc. Each property can be considered a key/value pair—a name of the property and its value. In other examples, entities represented as nodes include documents, meetings, communication, etc., as well as edges representing relations among these entities, such as, for example, an edge between a person node and a document node representing that person's authorship, modification, or viewing of the associated document. Two persons who have interacted with the same document, as in the above example, will be connected by one “hop” via that document with the other person, as each person's node shares an edge with the document's node. The graph database executes graph queries that are submitted by various users to return nodes or edges that satisfy various conditions (e.g., users within the same division of a company, the last X documents accessed by a given user).

Contextual information are parsed from the event to be transcribed, and unique vocabulary words may be added to the contextual dictionary 130 in addition to strengthening or weakening the confidence scores for existing words in the contextual dictionary 130 for selection based on syntax and phoneme matching.

In one example, where the event to be transcribed is a webinar, a presentation deck, a meeting handout document, a presenter list, and an attendee list associated with the webinar are parsed to identify words and names for contextual information. The contextual dictionary 130 is then adjusted so that names of presenters/attendees will be given greater consideration by the speech to text engine 120 when transcribing the speech data. For example, when an attendee has the name “Smith” recognized from the contextual information, when the speech to text engine 120 identifies phonemes corresponding to [smIθ], “Smith” will be selected with greater confidence relative to “smith”. Similarly, other variants or partial matches to [smI θ] (e.g., “Smyth”, “smithereens”, “smit”) are deprecated so that the relative confidence of “Smith” to match the phonemes for [smIθ] is increased.

In another example, where the event to be transcribed is a previously recorded portion of a meeting, a broadcast title and metadata (e.g., review, synopsis, source) are used to identify contextual information, such as, for example, character names, vocabulary lists, etc., which may be located on an internet database or program guide. For example, for an event of playback of a speech from a science fiction convention to be transcribed, a character named “Lor” is identified as contextual data for the event so that the speech to text engine 120 will have greater relative confidence in selecting “Lor” over “lore” when phonemes corresponding to [l [symbol] r] are identified in the speech data. Similarly, when the event specific term of “Berelian”—noted as having a pronunciation of [bεrεlian]—is identified as contextual data for the event, phonemes corresponding to [bεrεlian] will be associated with the term “Berelian” when identified in the speech data for conversion to text. In various aspects, phoneme correspondence to a textual term for contextual data is determined based on orthographical rules of construction and spelling or a pronunciation guide.

The contextual information is used to discover supplemental contextual information in the graph database according to one or more graph queries. The graph queries specify numbers, types, and strength of edges between nodes representing the entities discovered in the contextual information and nodes representing entities to use as supplemental contextual information. For example, when the name of an attendee is discovered as contextual information for the event to be transcribed (e.g., in an attendee list, as metadata or content in a document associated with the event), the node associated with that attendee in the graph database is used as a starting point for a graph query. The nodes spanned according to the graph query, such as, for example, other persons, other events, and other documents interacted with by the attendee (a first “hop” in the graph database) or discovered as having been interacted with by entities discovered after the first hop (a subsequent “hop” spanning outward from an earlier “hop” in the graph database) are mined to discover supplemental contextual information for the event to improve the contextual dictionary 130.

Consider the example in which an event to be transcribed is a meeting between department heads of an organization. The names of the department heads, talking points for the meeting, etc., are discovered as contextual information for the event from attendee/presenter lists, a meeting invitation, an attached presentation, etc. However, if the department heads were to discuss their subordinates by name (e.g., to discuss assigning action items), the names of the subordinates may not be present in the data searched for contextual information, and the contextual dictionary 130 may miss-weight the names of the subordinates, thus reducing the accuracy of the transcript, and requiring additional computing resources to correct the transcript. Instead, by querying the graph database for persons or documents related to the department heads, even when those persons or documents are not indicated in the event, the contextual dictionary 130 can be expanded to include or reweight terms and names discovered that may be spoken during the event.

For example, graph queries specify one or more of: nodes within X hops from a starting node, nodes having a node type of Y (e.g., person, place, thing, meeting, document), with a strength of at least Z, to specify what nodes are discovered and returned to augment the contextual dictionary 130 with supplemental contextual data. To illustrate in relation to the above example of a department head meeting, graph queries may specify (but are not limited to), the n most recently accessed documents for each department head, the p persons with whom each department head emails most frequently, the m most recently accessed documents for the p persons with whom each department head emails most frequently, all of the persons who have accessed the n most recently accessed documents, etc.

The key values (e.g., identity information) for the nodes discovered by spanning the graph database are used to discover the entities in various file repositories and databases. The names and terms from the data retrieved are parsed and are used as supplemental contextual information to augment the contextual dictionary 130. In various aspects, supplemental contextual information are given lower weights or less effect on existing weights of entries in the contextual dictionary 130 than contextual information.

The transcript database 140 stores one or more transcripts of textualized speech data received from the text to speech engine 120. The transcripts are synchronized with the audiovisual data to enable the provision of text in association with the audio used to produce that text. In various aspects, the transcripts are provided to the transcript database 140 as a stream while they are being produced by the speech to text engine 120 along with the audiovisual data to be transmitted, and may provide a complete or incomplete transcript for the audio visual data item at a given time. For example, a transcript may omit portions of the audiovisual content item to be transcribed when transcription began after the audiovisual content item began, thus leaving out the earlier portions of the content item from the transcript. In another example, an audiovisual content item may not be complete (e.g., a teleconference or other live event is ongoing), and the transcript, while up-to-date, is also not yet complete and is open to receive additional text data as additional audio data are received.

In various aspects, the transcript is provided to audience devices 150 and/or the audiovisual data source 110 for inclusion as captions to the audiovisual data. In other aspects, the transcript is provided to audience devices 150 as a text readout of the audiovisual data, regardless of whether the audience device 150 has received the audiovisual data on which the text data are based. The text data may be transmitted in band or out of band with any transmission of the audiovisual data according to broadcast standards, and may be incorporated into a stored version of the audiovisuals data or stored separately.

The audience device 150 in various aspects receives the audiovisual data and the transcript from the audiovisual data source 110 and the transcript database 140 respectively. In other aspects, the audience device 150 receives the transcript integrated into the audiovisual data received from the audiovisual data source 110. In yet other aspects, the audience device 150 receives the transcript from the transcript database 140 without receiving the audiovisual data from the audiovisual data source 110. In some aspects, the audience device 150 is in communication with the audiovisual data source 110 and the transcript database 140 to request changes in the content provided (e.g., request a transcript in a different language, request a different content item, to transmit feedback), while in other aspects, such as in a teleconference, the audience device 150 is an audiovisual data source 110 for its audiovisual data source 110 (which acts as an audience device 150 in turn).

One or more transcriptions 160 are produced for the audiovisual content item that are maintained in the transcript database 140. In various aspects, each transcript maintained in the transcript database 140 is associated with a given language associated with the users of audience devices 150 requesting those transcripts. For example, a first transcription 160a may be associated with the primary language in which the audiovisual content item was spoken, whereas a second transcription 160b is associated with second language, a third transcription 160c with a third language, a fourth transcription 160d associated with a fourth language, etc.

As creating a translation is expensive, either computationally or by human translators, a translation service 170 (computer, human, or computer-aided) will not be invoked until it is determined that a given language has been requested for the content item. A machine translation service 170 includes artificial intelligence and data processing components used to recognize meaning in one language and convert that meaning into words and phrases having equivalent meaning in another language. Examples of computer based translation services include, but are not limited to the GOOGLE TRANSLATE™, MICROSOFT TRANSLATE™, SLATE™, and XEROX EASY TRANSLATOR™ services (available from Alphabet, Inc. of Mountain View, Calif., Microsoft Corp. of Redmond, Wash., Precision Translation Tools Pte. Ltd of Singapore, and Xerox Corp. of Norwalk, Conn., respectively).

Requests for various languages may be received explicitly or implicitly from the users of the audience devices 150 or an operator of the audiovisual content source 110. For example, a user may explicitly request a translated transcript to be provided in Japanese for an English content item by specifying the Japanese language in the request. In another example, an implicit request for a Japanese language transcript is received when the request for the transcript is received from a user associated in a directory service with a Japanese location, from an audience device 150 determined to be located in Japan (e.g., via global positioning system (GPS) or Internet Protocol (IP) locational services), etc.

When a request is received for a translated transcript, translation services 170 are invoked on demand to provide the transcript in the requested language. In various aspects, the request includes a timestamp from which to provide the translated transcript from. For example, a timestamp of “Now” is provided when a user requests a translated transcript of an ongoing presentation, indicating that the translated transcript is to be provided in concert with a live event in real-time. In another example, a user accessing a completed content item's transcript or an already transcribed portion of an ongoing presentation (e.g., rewind or skip back in playback) a time stamp of s seconds from the start (or at an absolute time) is provided, from which the transcript and/or the content item are then provided to the user. When a user provides a timestamp for a previously provided portion of the content item, the transcript database 140 determines whether the transcript in the requested language already exists and provides the prior-created transcript or invokes the translation services 170 to provide the transcript in the requested language. When no users are requesting the transcript in a given language, the on demand translation and provision of the transcript will cease.

In aspects where the translated transcripts are produced from a time other than the initiation of the content item or stop prior to the end of the content item, an incomplete transcription 160 for a given language is produced. When an incomplete transcription 160 is produced, the translation service 170 may be invoked to backfill (or forefill) the gaps in the transcription 160 according to one or more prioritization schemes. As will be appreciated, the provision of requested on-demand translations are given priority over gap filling translations, so that in the event of constrained computing resources, those resources are devoted first to providing ongoing translations to viewers consuming the event.

For example, consider the transcriptions 160a-d in FIG. 1 to each represent the transcription 160 of a single content item for different languages that a user may request a translation for. As illustrated, each transcription 160 represents a status bar running the length of the content item being transcribed, which changes from white to black as translated content is added to the associated transcription 160. The first transcription 160a represents an initial language in which the content item was presented and is shown fully in black, indicating that its transcript is complete (or complete up to the point at which a live event has occurred). The second transcription 160b, associated with a second language, is shown mostly in black, but with areas of white indicating portions of the transcript have not been translated into the second language. The third transcription 160c, associated with a third language, is shown mostly in white, but with areas of black indicating portions of the transcript have been translated into the third language. The fourth transcription 160d, associated with a fourth language, is shown fully in white, indicating that no translation is yet available for the transcript of the given content item. As will be appreciated, these graphical representations are provided as illustrative examples.

In some aspects, prioritizing which incomplete transcriptions 160 to complete is based on the amount left to translate. As shown in the second transcription 160b, one or more users have been provided portions of the transcript in a second language, and as shown in the third transcription 160c, one or more users have been provided portions of the transcript in a third language, albeit a smaller portion than what has been provided in the second transcript 160b. In the illustrated example, the second transcription 160b is prioritized over the third transcription 160c due to there being less of the transcript required to translate to produce a fully translated second transcription 160b than a fully translated third transcription 160c.

For example, a user may join an online meeting in which captions in a given language are not initially active, but within a few minutes turns on an on-demand translation in that language and leaves it on for the remainder of the meeting. The on-demand translation provides a near real-time translation of the meeting's transcript onward from the time of activation, but a gap where no translation exists from the time of joining the meeting until activating the feature. Due to the size of the gap relative to the transcription 160, this gap may be prioritized for translation, to complete the transcription in the given language. In another example, when a user is curious about the captioning features and selects a language, such as, for example, Klingon, to provide captioning for the same meeting, but turns off the feature after a few minutes, the gaps in the translation may be large relative to the length of translated portions, and the Klingon translation will not be prioritized for filling in. Various time thresholds for incomplete portions, either relative to the duration of the event or absolute (e.g., m minutes or less), may be set to determine whether to prioritize completing the translation of a given transcript to fill its gaps.

In other aspects, a popularity or likelihood of a language's use is used to prioritize filling an incomplete transcription 160. In various aspects, the popularity or likelihood of use may be based on a speaking population of that language, a historic frequency of use of translation services 170 for the language, a location of the event, or current explicit requests. To illustrate, consider the first transcription 160a to represent an English language transcript, the second transcription 160b to represent a Swahili language transcript, the third transcription 160c to represent a Mandarin Chinese language transcript, and the fourth transcription 160d to represent a (potential) Klingon transcript, where the likelihood of each language to be requested is used to determine which incomplete transcriptions 160b-d to complete. In one example, where an organization has offices in an English speaking country and a Swahili speaking country, the second transcript 160b is prioritized for completion. In another example, because more persons speak Mandarin Chinese than do Swahili or Klingon, the third transcription 160c is prioritized for completion. In yet another example, in response to a user explicitly requesting Klingon, the fourth transcription 160d is prioritized. In a further example, an event given in English at a science fiction convention (wherein Klingon is a language associated with science fiction conventions), a Klingon language translation is prioritized.

A language that is associated with a likelihood that does not satisfy a popularity threshold may remain uncompleted in populating its transcription 160. For example, because Klingon is a constructed language associated with a low number of speakers, the associated fourth transcription 160d may remain unpopulated unless an explicit request for the transcript in Klingon is received. In another example, the partially complete second transcription 160b may remain incomplete until another user requests the transcript in Swahili if the likelihood of Swahili being requested again falls below a popularity threshold.

In yet further aspects, which portions of a transcript that have already translated are used to prioritize filling an incomplete transcription 160. In some aspects, when a third transcription 160c is requested during the playback of the content item (e.g., in the middle of a presentation), providing the portions of the third transcription 160c that were not previously requested in the third language may be prioritized, thus allowing the user to rewind or skip back to a previous section and receive the transcript in the chosen language at that portion of the content item. For example, when a Japanese speaker joins a multi-hour webinar presented in English a few minutes late and requests captioning in Japanese, the system will prioritize filling the gap from the beginning of the webinar to the time the user requested Japanese captioning due to the likelihood that the user may wish to cover missed portions of the webinar. Continuing the example, if the user who requested a Japanese transcript logs off from the webinar before it ends, the end portion may not be prioritized for translation, as its position in the event indicates that it may be unlikely that the user will return to watch that portion. Various likelihood thresholds may prioritize or deprioritize the translation of various sections of an event, such as, for example, based on a words-per-minute rate of the transcript, a location in the transcript (prioritize earlier remarks over later, deprioritize opening/closing remarks, etc.), or the number of attendees for the event during a time associated with the incomplete portion.

In some aspects, a content item may be multilingual, in which more than one language is spoken and recognized. Multilingual transcripts may be handled differently in different situations based on user settings, the frequency of use of different languages in the content item, and the similarity of content spoken once translated. Depending on the settings for the translation, content not spoken in the primary language may be ignored (left in the second language in the transcript), omitted (cut from the transcript), or translated (literally or idiomatically) in the transcript.

For example, a content item of a foreign language class webinar may include portions that are spoken first in a first language followed by a spoken translation in a second language that have been designated for transcription in both languages in the language that was spoken. In another example, a human translator may be in a meeting and repeats what a first party says in a first language to a second party in a second language (and vice versa), and the repeated content (in the second language) is omitted to reduce the amount of text in the transcript for the first language. In contrast, for a transcript for the second language, the repeated content in the first language may be omitted in the translator example. In a further example, a user of a first language may include the occasional bon mot in another language, which will be left untranslated in the transcript for the first language and different settings are applied to a transcript for a third language.

To illustrate, consider the French phase “c'est la vie” « that's life», which is used frequently in English speech and may part of a first transcription 160a in English. When a second transcription 160b in German is requested, the phrase “c'est la vie” may be literally translated into German as “dass ist Leben” « that is life», may remain untranslated as “c'est la vie”, or may be idiomatically translated into German as “so ist das Leben” « such is life». Additionally, the translation into the third language of a segment in a second language may be based upon its usage in the first language or its usage in the second language from which it was borrowed. For example, the Latin term “aurora borealis” «Northern Dawn» is used in English to denote the Northern Lights, and may be translated from either “Northern Dawn” or “Northern Lights” into a third language, such as, for example with German, as “nördliche Morgenröte” or “Nordlicht”, respectively.

Terms added to the contextual dictionary 130 that are specific to the event being transcribed may be marked as translatable or non-translatable between different languages in various aspects. For example, if the speech to text engine 120 detects the phonemes [smI θ], which correspond to “smith” or “Smith” and determines that the name “Smith”, which was added as contextual information, is to be used, “Smith” is marked as a non-translatable name. Therefore, when a user requests a German translation, the transcription 160 will include the name “Smith” where it appears in the English translation and not the translation “Schmidt” «smith».

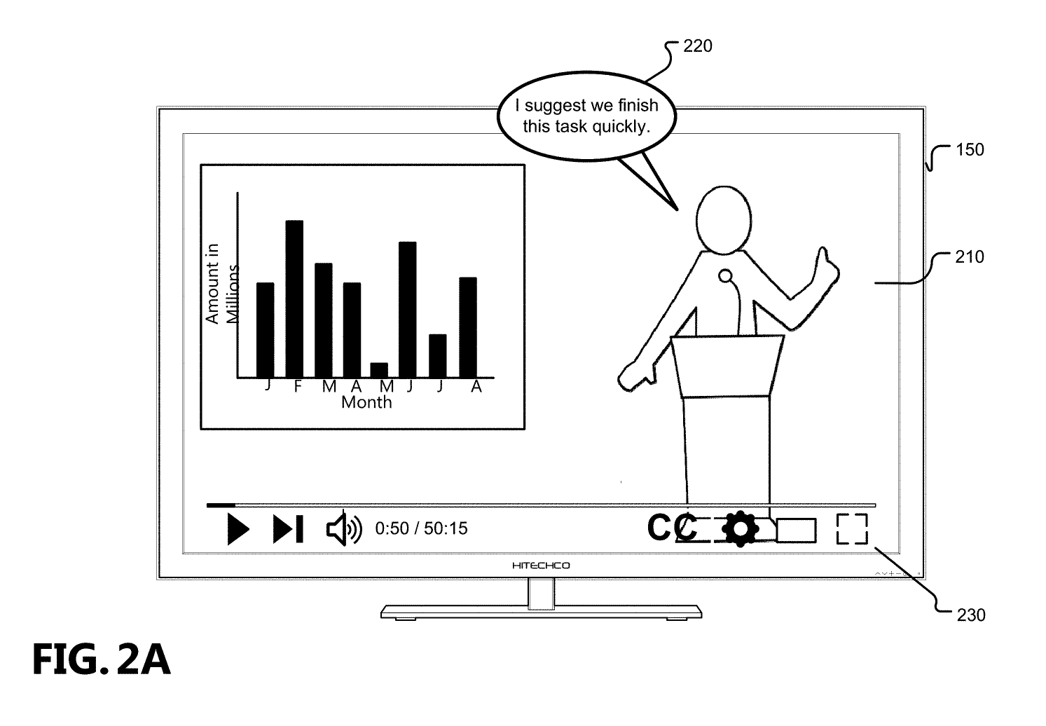

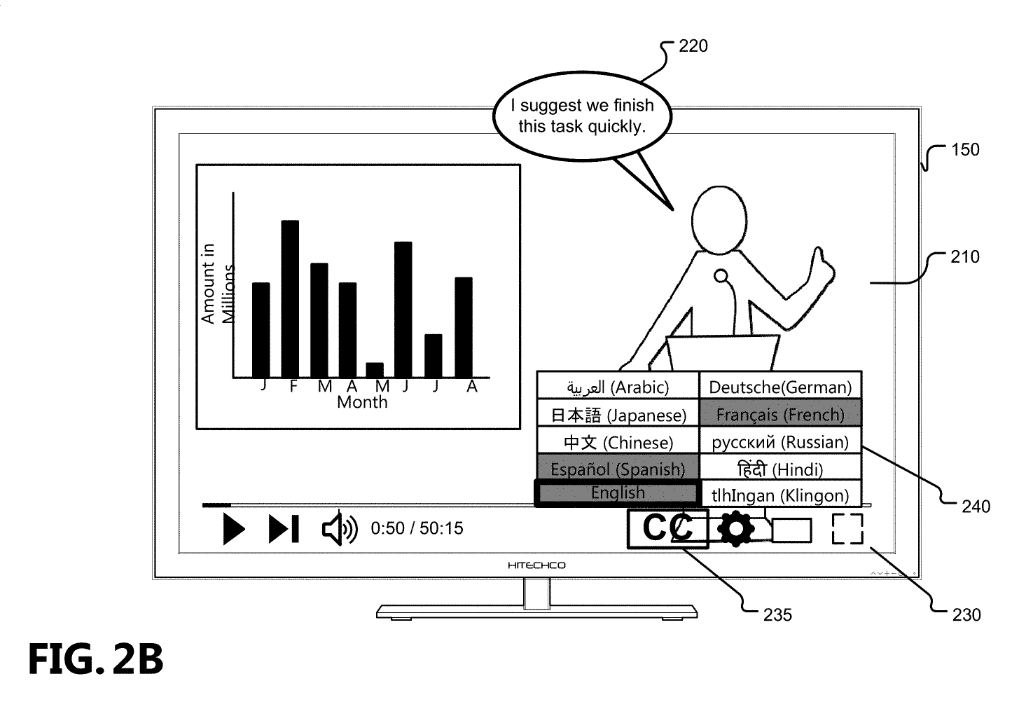

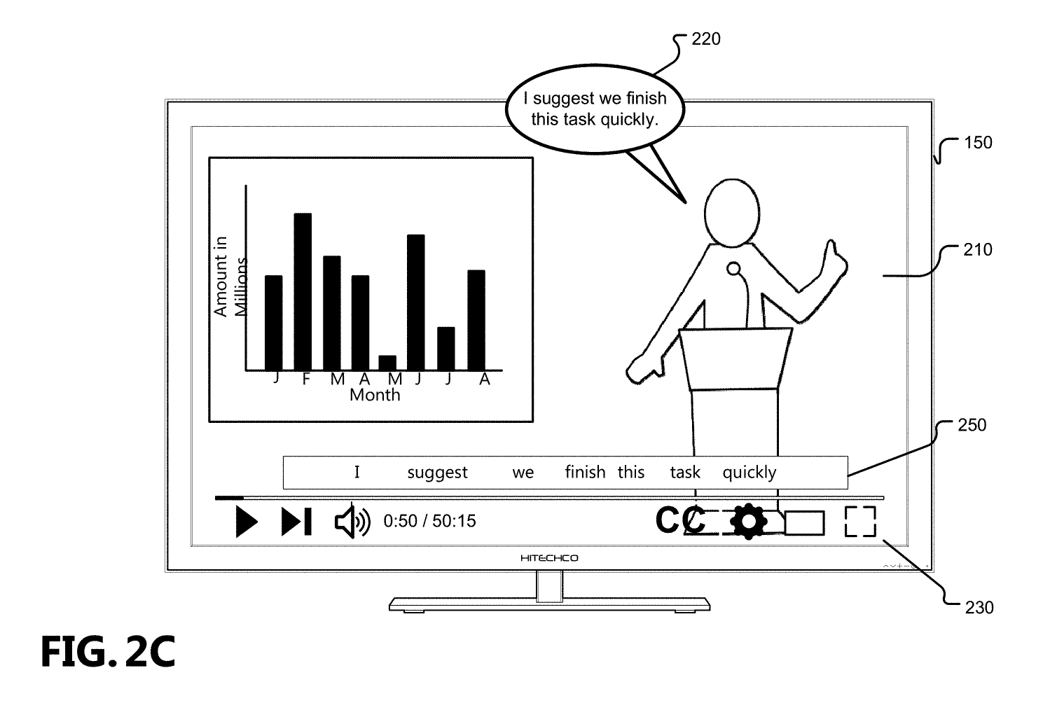

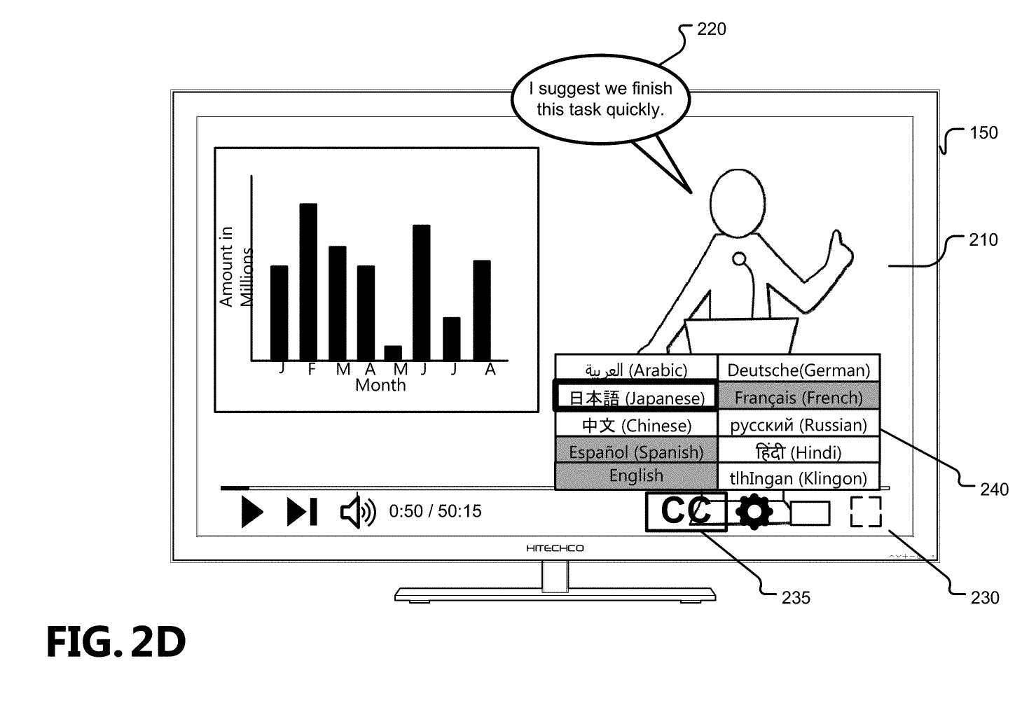

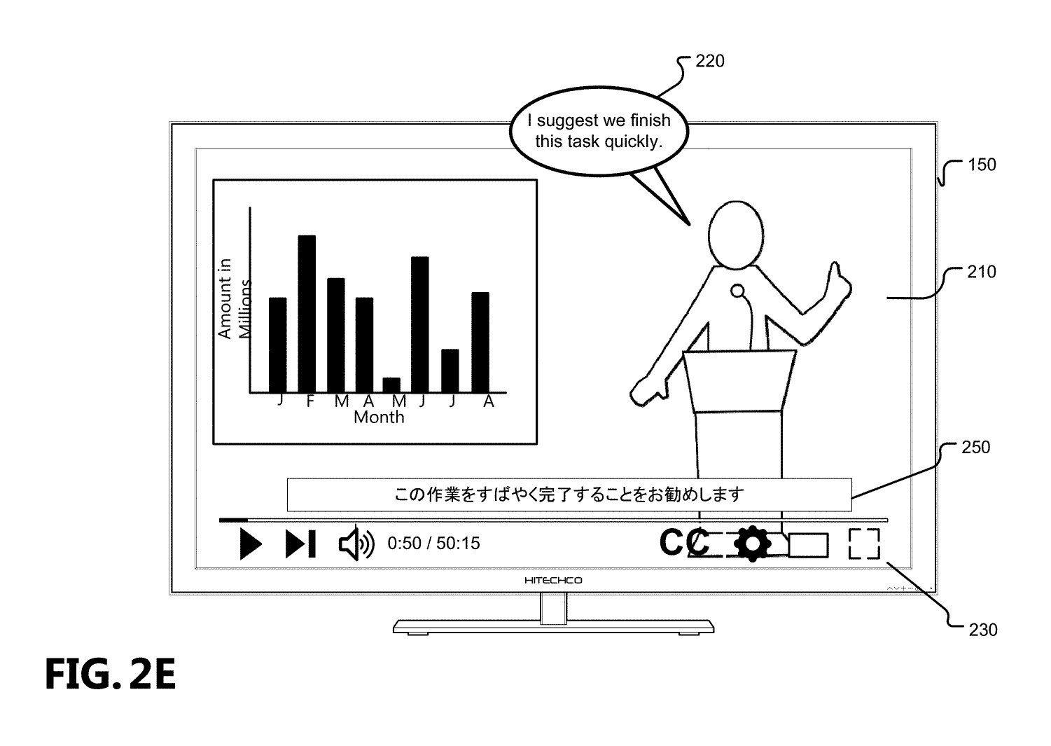

FIGS. 2A-E are example graphical user interfaces in which the various aspects of the disclosure are illustrated. As illustrated in FIG. 2A, a content item 210 is provided on the audience device 150 with an original audio 220. A control bar 230 is provided with various options including a closed caption option 235. The original audio 220 includes the phase, in English, of “I suggest we finish this task quickly”.

Upon selection of the closed caption option 235, the user is provided with an interface 240 as illustrated in FIG. 2B. The interface 240 provides the user with various language options such as, Arabic, Japanese, Chinese, Spanish, German, French, Russian, Hindi, Klingon, etc., into which the transcript may be translated for provision as closed captioning for the content item. As can be appreciated, more language options or fewer language options than shown in the interface 240 may be provided in other aspects.

As illustrated in FIG. 2B upon selection of the language “English”, the user is provided with the user interface as illustrated in FIG. 2C, where closed captioning 250 for the original audio 220 is displayed on the audience device 150 in English. In various aspects, when a transcription 160 already exists for a language displayed in the interface 240 (whole or partial), various indicators of its availability are shown, such as a fill bar, color coding, percentage indicator, or icon. As illustrated, for example, languages associated with completed transcriptions 160 are shown with a darker background in the interface 240 than those with incomplete transcriptions 160.

As illustrated in FIG. 2D, upon selection of the language “Japanese”, the user is provided with the user interface as illustrated in FIG. 2E, where closed captioning 250 for the original audio 220 is displayed on the audience device in Japanese. In various aspects, the original audio 220 is still provided on the audience device 150 in concert with the content item 210, regardless of the requested language for the translated transcription 160. In other aspects, the audience device 150 may incorporate a text to speech engine and provide a translated audio based on the transcription 160 provided in another language than that initially used in the content item 210.

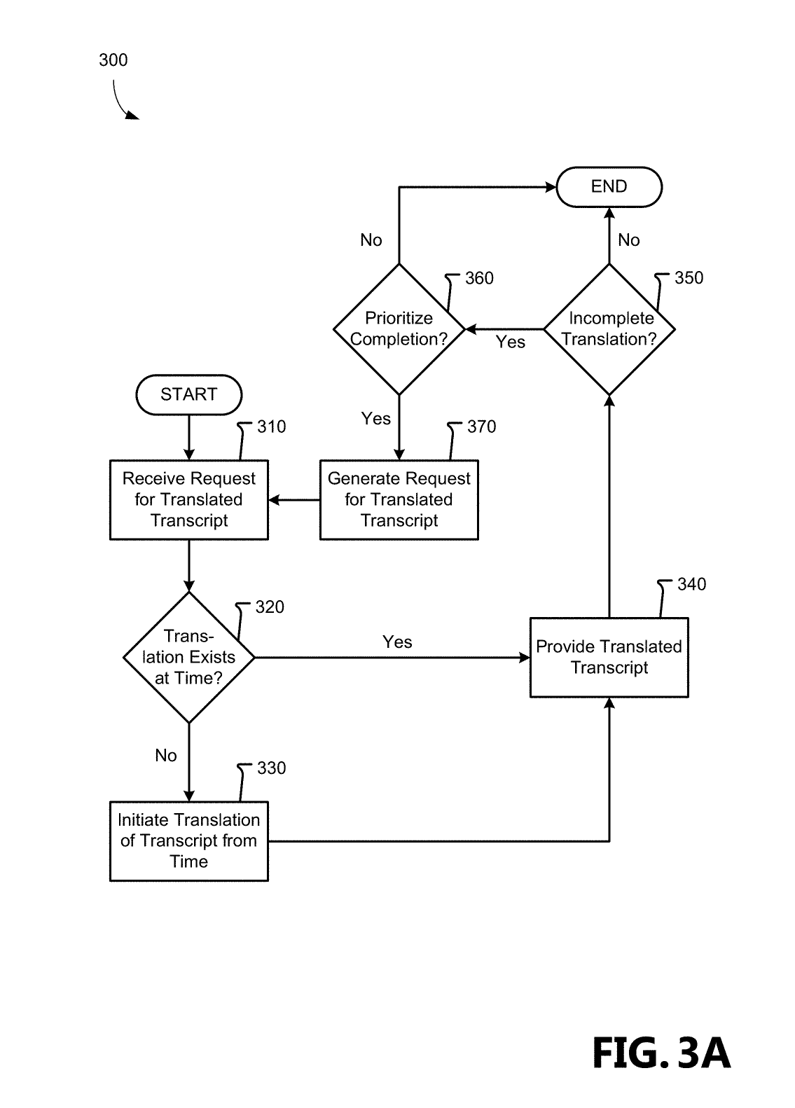

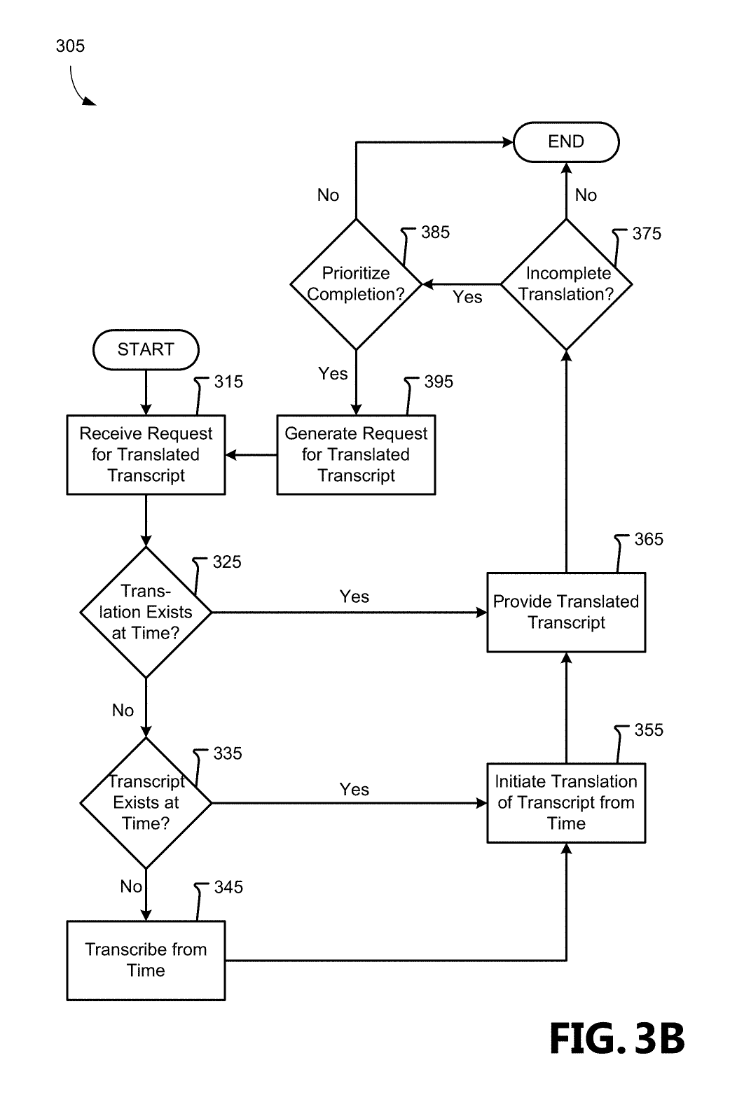

FIG. 3A is a flow chart showing general stages involved in an example method 300 for providing on-demand transcription and translations thereof. Method 300 begins at OPERATION 310, where a request for a translated transcript is received at the transcript database 140. The request includes a specified language for the transcript and a time from which to provide the transcript. In various aspects, a user may request the entire transcript (e.g., all times) as a read out, word processor document, or the like. In other aspects, the user may request the transcript to be displayed in concert with the event from which it was transcribed. In further aspects, the transcript database 140 requests a transcription 160 in anticipation of an audience device 150 requesting a translation, which will be stored in the transcript database 140 for later provision. The translated transcript may be displayed as closed captions on the audience device 150 and/or provided to a text to speech system to be read aloud by the audience device 150. The specified time in the request may designate a given time in an event that has already occurred (e.g., a timestamp in a recorded item, a delayed time s seconds back from “live” for an ongoing event, or real-time display as “now” in an ongoing event).

In various aspects, audience devices 150 transmit requests for translated transcripts at intervals during the event (e.g., every s seconds) so that as users stop viewing the event, translation may be ceased. In other aspects, requesting transcripts at intervals allows for a partial translation of the transcript to occur in blocks of time, so that the transcript database 140 is configured to request and store transcript translations in blocks of time and switch the provision of on-demand and pre-translated translations as pre-translated translation become or are no longer available. In additional aspects, providing translation in blocks allows for semantic and textual context for idiomatic translation to be provided to the translation services 170. For example, a language that has sentences structured in subject-object-verb (like Japanese) can be translated more readily and with greater fidelity to a language with a different sentence structure (like subject-verb-object in English) when blocks of the transcription are provided for translation. To illustrate, the sentence “it is beautiful” is rendered in Japanese (according to one Romanization) as “kirei desu”, where “desu” corresponds to the portion “it is” in English and “kirei” to the portion “beautiful” in English. In another illustration, the English sentence “I can help you” can be rendered in German as “ich kann dich helfen” where the verb phrase “can help” is broken in two by the object “dich” such than “kann” «can» and “helfen” «help» are not in the same positions as they are the English sentence. By providing the sentence as a block or as part of a block, mechanical word-by-word translation is avoided so that different sentence structures and contextual information may be accounted for by the translations service.

At DECISION 320 it is determined whether a transcript in the given language already exists in the transcript database 140 from the given time. For example, if the initial language is English, the initial transcription 160a will exist in the transcript database 140, but transcriptions 160 in German, Swahili, Klingon, etc., may or may not yet exist in the transcript database 140, and those translated transcriptions 160 may be incomplete; the translation may exist at times other than the specified time for the specified language. In another example, during a live event, in which the initial language transcription 160 is still being added to as the event proceeds, the translation for the specified language from a specified time of “now” in will be determined to not currently exist. When it is determined at DECISION 320 that a translation does currently exist for a specified language at a specified time, method 300 proceeds to OPERATION 340.

When it is determined at DECISION 320 that a translation does not currently exist for a specified language at a specified time, method 300 proceeds to OPERATION 330. At OPERATION 330 translation is initiated according to the specified language from the specified time. In various aspects, real-time translation of the transcript occurs, wherein the translated transcription 160 is stored in the transcript database 140 for provision to various audience devices 150. In other aspects, backfilling or pre-filling of recorded content that the requestor or another user is expected to request also occurs to fill in gaps of the transcription 160 that have not yet been translated. In various aspects, gap filling of one or more non-translated portions of an incompletely translated transcript and live translation occur simultaneously. For example, more than one request to translate the transcript may be received at OPERATION 310 that may be handled concurrently. Once the translation is complete, whether in a block (e.g., s seconds of content, a sentence, w words) or word-by-word, method 300 proceeds to OPERATION 340.

At OPERATION 340 the translated transcription 160 is provided. In some aspects, the translated transcription 160 is provided to the audience device 150 for display in concert with the audiovisual content of the event as captions. In other aspects, the translated transcription 160 is provided at one time, such as in a word processor document. The translated transcription 160 is stored in the transcript database 140 for later provision to an audience device 150, which may be done in addition to or instead of transmitting the translation to the audience device 150 (e.g., in preparation for a request specifying a given time and language).

Proceeding to DECISION 350, it is determined whether the translation is incomplete. When an event is ongoing and the user has requested live translation, it is determined that the translation is incomplete. Similarly, when a user has requested ongoing playback of a recorded portion of an event (completed or ongoing) in a section that has not been translated before, it is determined that the translation is incomplete. In another example, when a user did not request translation from the beginning of an event, stopped requesting translation before the end of an event, or otherwise left a gap in the translated transcription 160, it is determined that the translation is incomplete. When there are no gaps in the translated transcription 160, it is considered complete, and method 300 may conclude. In response to determining that the translated transcription 160 for the given language is incomplete, method 300 proceeds to DECISION 360.

At DECISION 360 it is determined whether to prioritize completion of the transcription 160 for the given event in the given language. One or more features of the transcription 160 and the language are used in coordination with one or more thresholds (e.g., a popularity threshold, a likelihood threshold, a time threshold) to determine whether one or more untranslated portions of the transcription 160 should be prepopulated in anticipation of a request for the transcription 160 in a given language. When it is determined that the translation of the incomplete translation is not to be prioritized at the current time, method 300 may conclude. When it is determined that the translation of the incomplete translation is to be prioritized at the current time, method 300 proceeds to OPERATION 370.

At OPERATION 370 a request for a translated transcript is generated for the specified language, and method 300 returns to OPERATION 310 to continue providing the translated transcript. In various aspects, the time specified in the request is chosen based on a most-likely section to be request in the future by an audience device 150. The most-likely section in some aspects is chosen as the subsequent untranslated portion of the transcript, while in other aspects, the time selected for the most-likely section is an earliest time in the transcript that is not translated, or another portion of the transcription 160 that is associated with a high likelihood of being requested (e.g., based on words-per-minute in the initial language's transcription 160, proximity to a break (an intermission, chapter heading, slide transition, etc.) in the event).

FIG. 3B is a flow chart showing general stages involved in an example method 305 for providing on-demand transcription and translations thereof when an initial transcript may not yet exist. Method 305 begins at OPERATION 315, where a request for a translated transcript is received at the transcript database 140. The request includes a specified language for the transcript and a time from which to provide the transcript. In various aspects, a user may request the entire transcript (e.g., all times) as a read out, word processor document, or the like. In other aspects, the user may request the transcript to be displayed in concert with the event from which it was transcribed. In further aspects, the transcript database 140 requests a transcription 160 in anticipation of an audience device 150 requesting a translation, which will be stored in the transcript database 140 for later provision. The translated transcript may be displayed as closed captions on the audience device 150 and/or provided to a text to speech system to be read aloud by the audience device 150. The specified time in the request may designate a given time in an event that has already occurred (e.g., a timestamp in a recorded item, a delayed time s seconds back from “live” for an ongoing event, or real-time display as “now” in an ongoing event).

In various aspects, audience devices 150 transmit requests for translated transcripts at intervals during the event (e.g., every s seconds) so that as users stop viewing the event, translation may be ceased. In other aspects, requesting transcripts at intervals allows for a partial translation of the transcript to occur in blocks of time, so that the transcript database 140 is configured to request and store transcript translations in blocks of time and switch the provision of on-demand and pre-translated translations as pre-translated translation become or are no longer available. In additional aspects, providing translation in blocks allows for semantic and textual context for idiomatic translation to be provided to the translation services 170. For example, a language that has sentences structured in subject-object-verb (like Japanese) can be translated more readily and with greater fidelity to a language with a different sentence structure (like subject-verb-object in English) when blocks of the transcription are provided for translation. To illustrate, the sentence “it is beautiful” is rendered in Japanese (according to one Romanization) as “kirei desu”, where “desu” corresponds to the portion “it is” in English and “kirei” to the portion “beautiful” in English. In another illustration, the English sentence “I can help you” can be rendered in German as “ich kann dich helfen” where the verb phrase “can help” is broken in two by the object “dich” such than “kann” «can» and “helfen” «help» are not in the same positions as they are the English sentence. By providing the sentence as a block or as part of a block, mechanical word-by-word translation is avoided so that different sentence structures and contextual information may be accounted for by the translations service.

At DECISION 325 it is determined whether a transcript in the given language already exists in the transcript database 140 from the given time. For example, if the initial language is English, the initial transcription 160a may exist in the transcript database 140, but transcriptions 160 in German, Swahili, Klingon, etc., may or may not yet exist in the transcript database, and those translated transcriptions 160 may be incomplete; the translation may exist at times other than the specified time for the specified language. In another example, during a live event, in which the initial language transcription 160 is still being added to as the event proceeds, the translation for the specified language from a specified time of “now” in will be determined to not currently exist. When it is determined at DECISION 325 that a translation does currently exist for a specified language at a specified time, method 300 proceeds to OPERATION 365.

When it is determined at DECISION 325 that a translation does not currently exist for a specified language at a specified time, method 300 proceeds to DECISION 335, where it is determined whether a transcript in the initial language has been created at the given time. If the transcript exists in the initial language (the language in which the event was presented), method 300 proceeds to OPERATION 355. If it is determined that the transcript in the initial language does not exist at the given time, method 300 proceeds to OPERATION 345.

Transcription of the event in its initial language from the given time is begun at OPERATION 345 in response to the initial transcription 160 not existing at the given time. An initial language transcription 160 may not exist at the given time, for example, when no transcript has been developed or when a partial transcript has been developed that does not include the given time. The speech data extracted from the audiovisual data are converted by the speech to text engine 120 into the initial language's transcription 160. In various aspects, when the speech to text engine 120 produces an incomplete initial language transcription 160 (e.g., from a time other than the start to a time other than the end of the event), the initial language transcription 160 may be left incomplete until a later request (for transcription in the initial language or transcription in another language) or the transcription may be completed (backfilling skipped portions or forefilling sections that have not yet been transcribed).

At OPERATION 355 translation is initiated according to the specified language from the specified time. In various aspects, real-time translation of the transcript occurs, wherein the translated transcription 160 is stored in the transcript database 140 for provision to various audience devices 150. In other aspects, backfilling or pre-filling of recorded content that the requestor or another user is expected to request also occurs to fill in gaps of the transcription 160 that have not yet been translated. In various aspects, gap filling of one or more non-translated portions of an incompletely translated transcript and live translation occur simultaneously. For example, more than one request to translate the transcript may be received at OPERATION 315 that may be handled concurrently. Once the translation is complete, whether in a block (e.g., s seconds of content, a sentence, w words) or word-by-word, method 300 proceeds to OPERATION 365.

At OPERATION 365 the translated transcription 160 is provided. In some aspects, the translated transcription 160 is provided to the audience device 150 for display in concert with the audiovisual content of the event as captions. In other aspects, the translated transcription 160 is provided at one time, such as in a word processor document. The translated transcription 160 is stored in the transcript database 140 for later provision to an audience device 150, which may be done in addition to or instead of transmitting the translation to the audience device 150 (e.g., in preparation for a request specifying a given time and language).

Proceeding to DECISION 375, it is determined whether the translation is incomplete. When an event is ongoing and the user has requested live translation, it is determined that the translation is incomplete. Similarly, when a user has requested ongoing playback of a recorded portion of an event (completed or ongoing) in a section that has not been translated before, it is determined that the translation is incomplete. In another example, when a user did not request translation from the beginning of an event, stopped requesting translation before the end of an event, or otherwise left a gap in the translated transcription 160, it is determined that the translation is incomplete. When there are no gaps in the translated transcription 160, it is considered complete, and method 300 may conclude. In response to determining that the translated transcription 160 for the given language is incomplete, method 300 proceeds to DECISION 385.

At DECISION 385 it is determined whether to prioritize completion of the transcription 160 for the given event in the given language. One or more features of the transcription 160 and the language are used in coordination with one or more thresholds (e.g., a popularity threshold, a likelihood threshold, a time threshold) to determine whether one or more untranslated portions of the transcription 160 should be prepopulated in anticipation of a request for the transcription 160 in a given language. When it is determined that the translation of the incomplete translation is not to be prioritized at the current time, method 300 may conclude. When it is determined that the translation of the incomplete translation is to be prioritized at the current time, method 300 proceeds to OPERATION 395.

At OPERATION 395 a request for a translated transcript is generated for the specified language, and method 300 returns to OPERATION 315 to continue providing the translated transcript. In various aspects, the time specified in the request is chosen based on a most-likely section to be request in the future by an audience device 150. The most-likely section in some aspects is chosen as the subsequent untranslated portion of the transcript, while in other aspects, the time selected for the most-likely section is an earliest time in the transcript that is not translated, or another portion of the transcription 160 that is associated with a high likelihood of being requested (e.g., based on words-per-minute in the initial language's transcription 160, proximity to a break (an intermission, chapter heading, slide transition, etc.) in the event).

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which examples are practiced. However, the devices and systems illustrated and discussed with respect to FIGS. 4-6 are for purposes of example and illustration and are not limiting of a vast number of computing device configurations that are utilized for practicing aspects, described herein.

FIG. 4 is a block diagram illustrating physical components (i.e., hardware) of a computing device 400 with which examples of the present disclosure may be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. According to an aspect, the system memory 404 includes one or more of the audiovisual data source 110, the speech to text engine 120, the contextual dictionary 130, the transcript database 140, or the translation services 170. The operating system 405, for example, is suitable for controlling the operation of the computing device 400. Furthermore, aspects are practiced in conjunction with a graphics library, other operating systems, or any other application program, and are not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

As stated above, according to an aspect, a number of program modules and data files are stored in the system memory 404. While executing on the processing unit 402, the program modules 406 perform processes including, but not limited to, one or more of the stages of the methods 300 and 305 illustrated in FIGS. 3A and 3B. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 4 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 400 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

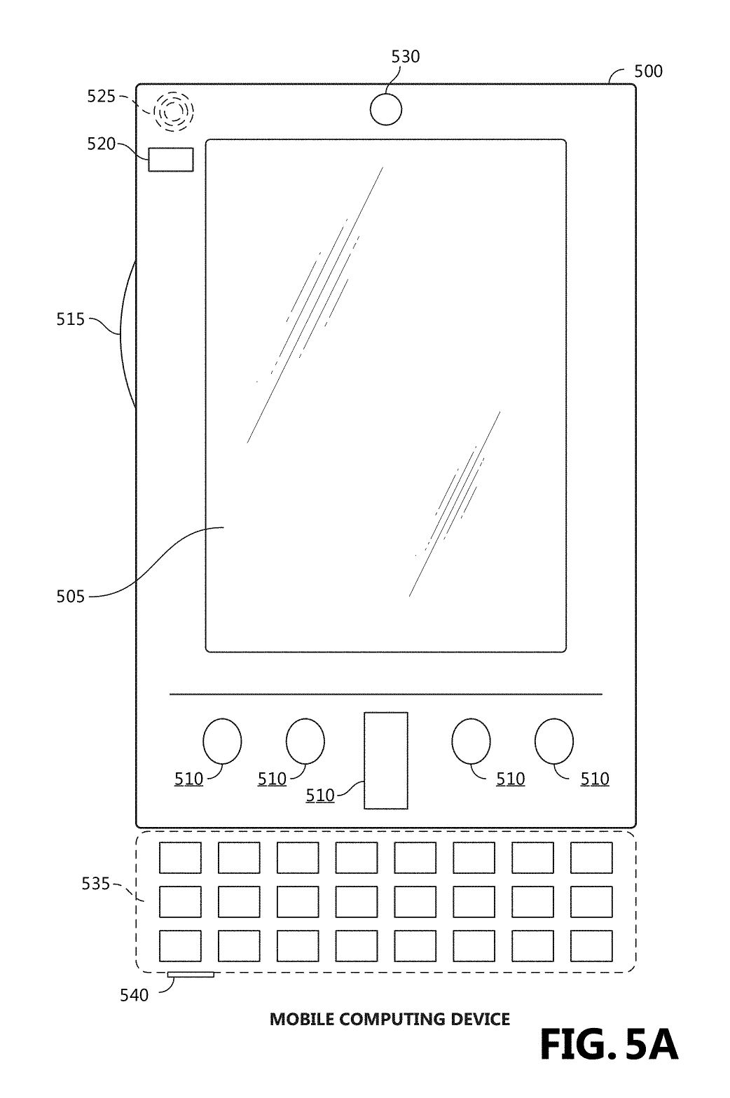

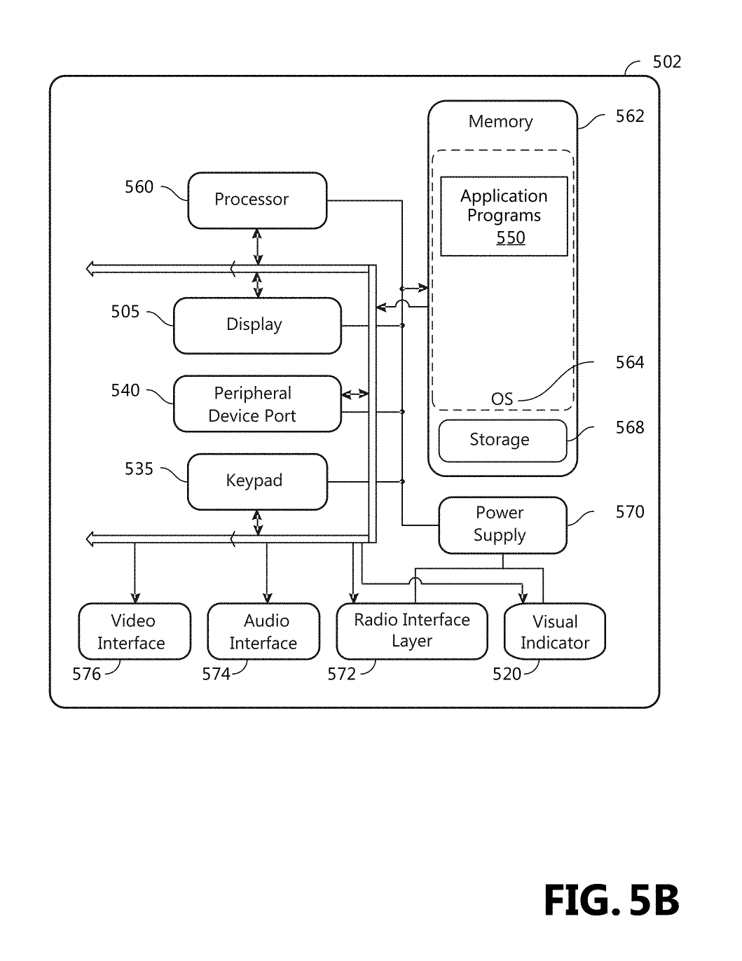

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or fewer input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 are stored locally on the mobile computing device 500, as described above. According to another aspect, the data are stored on any number of storage media that are accessible by the device via the radio 572 or via a wired connection between the mobile computing device 500 and a separate computing device associated with the mobile computing device 500, for example, a server computer in a distributed computing network, such as the Internet. As should be appreciated such data/information are accessible via the mobile computing device 500 via the radio 572 or via a distributed computing network. Similarly, according to an aspect, such data/information are readily transferred between computing devices for storage and use according to well-known data/information transfer and storage means, including electronic mail and collaborative data/information sharing systems.

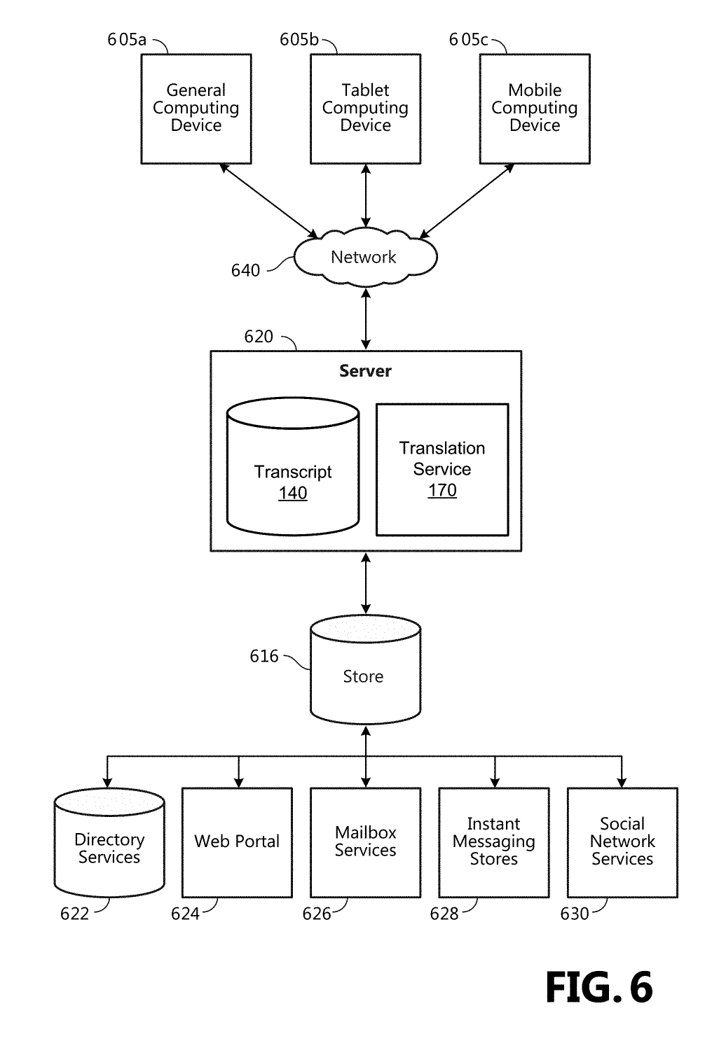

FIG. 6 illustrates one example of the architecture of a system for developing one or more transcriptions 160 on demand as described above. Content developed, interacted with, or edited in association with the transcript database 140, such as transcriptions 160, is enabled to be stored in different communication channels or other storage types. For example, various documents may be stored using a directory service 622, a web portal 624, a mailbox service 626, an instant messaging store 628, or a social networking site 630. The transcript database 140 and/or translation service 170 are configured to use any of these types of systems or the like for developing transcriptions 160, as described herein. According to an aspect, a server 620 provides the dictionary builder 160 to clients 605a,b,c. As one example, the server 620 is a web server providing the transcript database 140 and/or translation service 170 over the web. The server 620 provides the transcripts 160 over the web to clients 605 through a network 640 and transcript database 140 and/or translation service 170 may be integrated into a speech to text engine 120 or run as independent services. By way of example, the client computing device is implemented and embodied in a personal computer 605a, a tablet computing device 605b or a mobile computing device 605c (e.g., a smart phone), or other computing device. Any of these examples of the client computing device are operable to obtain content, such as transcriptions 160, from the store 616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A system, comprising:
a processor; and
a memory storage device including instructions that when executed by the processor are operable to provide a transcript database in communication with translation services, the transcript database configured to:
receive a request for a transcription of an event, the request specifying a given language and a given time in the event;
determine whether the transcription of the event exists for the given language from the given time;
in response to determining that the transcription of the event exists for the given language from the given time, provide the transcription of the event for the given language from the given time to an audience device; and
in response to determining that the transcription of the event does not exist for the given language from the given time,
identify an initial language transcription of the event from the given time made in an initial language of the event;
transmit, to the translation service, the initial language transcription of the event from the given time;
receive, from the translation service, a translated transcription from the given time according to the given language;
store the translated transcription; and
provide the translated transcription from the given time to an audience device.

2. The system of claim 1, wherein the event is an online meeting and the translated transcription is provided in real-time as the event is transmitted to the audience device; wherein the specified time indicates that the translated transcription is to be provided in concert with a live event.

3. The system of claim 1, wherein transcript database is further configured to:
transcribe the event from the given time in the initial language to produce the initial language transcription in response to not identifying the initial language transcription.

4. The system of claim 1, wherein the transcript database is further configured to:
signal the translation service to cease translation of the initial language transcription in response to no audience devices requesting the translated transcription according to the given language.

5. The system of claim 1, wherein the translated transcription includes an untranslated portion, the transcript database is further configured to:
transmit, to the translation service, the initial language transcription of the event associated with the untranslated portion;
receive, from the translation service, a translated portion according to the given language; and
store the translated portion in association with the translated transcription.

6. A method, comprising:
receiving a request to translate a transcript for an event provided in a first language, the request indicating a second language and a specified time in the event;
determining whether a translation for the second language exists at the specified time;
in response to determining that the translation exists for the second language at the specified time:
providing a transcription of the event from the specified time according to the second language;
determining whether the transcription translated according to the second language is incomplete;
in response to determining that the transcription translated according to the second language is incomplete, determining whether to translate an untranslated portion of the transcription according to the second language; and
in response to determining to translate the untranslated portion according to the second language, translating the untranslated portion according to the second language.

7. The method of claim 6, further comprising:
determining whether the transcription translated according to the second language exists from the specified time;
in response to determining that the transcription translated according to the second language exists from the specified time, providing the transcription translated according to the second language from the specified time to an audience device in concert with the event; and
in response to determining that the transcription translated according to the second language does not exist from the specified time, initiating translation of the transcription of the event from the specified time according to the second language and providing the providing the transcription translated according to the second language from the specified time to the audience device in concert with the event.

8. The method of claim 7, wherein the event is an online meeting and the transcription is provided in real-time as the event is transmitted to the audience device.

9. The method of claim 6, wherein the second language is indicated according to context.

10. The method of claim 9, wherein the context is inferred for the audience device based on:
a global positioning system; or
an Internet Protocol Location service.

11. The method of claim 6, wherein determining whether to translate the untranslated portion according to the second language further comprises:
determining whether the untranslated portion of the transcription according to the second language satisfies a time threshold for completing translation; and
in response to determining that the untranslated portion satisfies the time threshold, completing the translation of the untranslated portion according to the second language.

12. The method of claim 6, wherein determining whether to translate the untranslated portion according to the second language further comprises:
determining whether the second language satisfies a popularity threshold for completing translation; and
in response to determining that the second language satisfies the popularity threshold, completing the translation of the transcription according to the second language.

13. The method of claim 12, wherein the popularity threshold is based on one or more of:
a speaking population of the second language;
a historic frequency of use of the second language; and
a location of the event.

14. The method of claim 6, wherein determining whether to translate the untranslated portion according to the second language further comprises:
determining whether the untranslated portion of the transcription according to the second language satisfies a likelihood threshold for being requested; and
in response to determining that the untranslated portion satisfies the likelihood threshold, completing the translation of the untranslated portion according to the second language.

15. The method of claim 14, wherein the likelihood threshold is based on one or more of:
a words-per-minute rate of the transcript;
a file path of the incomplete portion in the transcript; and
a number of attendees for the event during a time associated with the incomplete portion.

16. The method of claim 6, wherein the transcript includes contextual terms from a contextual dictionary developed for the event, wherein the contextual terms remain untranslated in the transcription according to the second language.

17. A computer readable storage device, including instructions executable by a processor, comprising:
receiving a request to translate a transcript for an event provided in a first language, the request indicating a second language and a specified time in the event;
determining whether a translation for the second language exists at the specified time;
in response to determining that the translation does not exist:
initiating translation of a transcription of the event from the specified time according to the second language; and
providing the transcription translated according to the second language to an audience device;
determining whether to continue translation of the transcription according to the second language; and
in response to determining to continue translation of the transcription according to the second language:
continuing translation of a transcription of the event from the specified time according to the second language; and
providing the transcription translated according to the second language to the audience device.

18. The computer readable storage device of claim 17, wherein the transcription translated according to the second language is translated in real-time for provision as captions to display on the audience device in concert with the event.

19. The computer readable storage device of claim 17, wherein it is determined to not continue translation of the transcript in response to the audience device no longer participates in the event.

20. The computer readable storage device of claim 17, wherein it is determined to continue translation of the transcript to fill gaps in a partially translated transcript.
